(19) United States
(12) Patent Application Publication
(10) Pub. No.: US 2021/0046703 A1
(43) Pub. Date: Feb. 18, 2021

(54) DEVICE AND METHOD FOR PRODUCING THREE-DIMENSIONAL WORKPIECES

(71) Applicant: SLM SOLUTIONS GROUP AG, Lübeck (DE)

(72) Inventors: Birk Hoppe, Lübeck (DE); Jan Wilkes, Lübeck (DE); Lukas Roesgen, Lübeck (DE)

(21) Appl. No.: 16/612,250

(22) PCT Filed: Apr. 19, 2018
(86) PCT No.: PCT/EP2018/060075

§ 371 Date: Nov. 8, 2019

(30) Foreign Application Priority Data
May 19, 2017 (DE) 10 2017 208 496.0

(51) Int. Cl. B29C 64/245; B33Y 10/00; B33Y 30/00; B29C 64/153; B29C 64/232; B29C 64/35; B33Y 40/00

(52) U.S. Cl. CPC B29C 64/245; B33Y 10/00; B33Y 30/00; B33Y 40/00; B29C 64/232; B29C 64/35; B29C 64/153

(57) ABSTRACT

The invention relates to a device for producing three-dimensional workpieces, The device comprises a carrier for receiving raw material powder and a radiation unit for selectively radiating the raw material powder applied to the carrier with electromagnetic radiation or particle radiation in order to produce on the carrier a workpiece made of the raw material powder by a generative layering construction process. The device also comprises a vertical movement means, which is designed to move the radiation unit vertically relative to the carrier, and a cylinder construction wall, which extends substantially vertically and which constitutes a lateral delimitation for the raw material powder applied to the carrier, wherein the cylinder construction wall is designed to increase its vertical height during the construction process.

invention relates to a device and a method for producing three-dimensional workpieces. In particular, the invention relates to a device and a method for producing three-dimensional workpieces by means of an additive layer building method.

In additive methods for producing three-dimensional workpieces, and in particular in additive layer building methods, it is known to apply an initially shapeless or shape-neutral molding compound (for example a raw material powder) to a carrier layer by layer and to solidify it by location-specific irradiation (e.g. by fusion or sintering) in order ultimately to obtain a workpiece of a desired shape. Irradiation can take place by means of electromagnetic radiation, for example in the form of laser radiation. In a starting state, the molding compound can initially be in the form of granules, powder or liquid molding compound and can be selectively or, in other words, location-specifically solidified as a result of the irradiation. The molding compound can comprise, for example, ceramics, metal or plastics materials and also material mixtures thereof. A variant of additive layer building methods relates to so-called powder bed fusion, in which in particular metallic and/or ceramics raw material powder materials are solidified to form three-dimensional workpieces.

In order to produce individual workpiece layers it is further known to apply raw material powder material in the form of a raw material powder layer to a carrier and to irradiate it selectively and in accordance with the geometry of the workpiece layer that is currently to be produced. The laser radiation penetrates the raw material powder material and solidifies it, for example as a result of heating, which causes fusion or sintering. Once a workpiece layer has solidified, a new layer of unprocessed raw material powder material is applied to the workpiece layer which has already been produced. Known coater arrangements or powder application devices can be used for this purpose. Irradiation is then again carried out on the raw material powder layer which is now uppermost and is as yet unprocessed. Consequently, the workpiece is gradually built up layer by layer, each layer defining a cross-sectional area and/or a contour of the workpiece. It is further known in this connection to use

or comparable workpiece data in order to manufacture the workpieces substantially automatically.

An irradiation unit, or an irradiation system, which can be used, for example, in a device for producing three-dimensional workpieces by irradiation of raw material powder materials is described in EP 2 333 848 B1. The irradiation system comprises a radiation source, in particular a laser source, and an optical unit. The optical unit, to which a processing beam emitted by the radiation source is provided, comprises a beam widening unit and a deflection device in the form of a scanner unit. Within the scanner unit, diffractive optical elements are provided in front of a deflection mirror, wherein the diffractive optical elements are movable into the beam path in order to split the processing beam into a plurality of processing sub-beams. The deflection mirror then serves to deflect the processing sub-beams.

It will be appreciated that all the aspects discussed above can likewise be provided within the scope of the present invention.

Known devices for producing three-dimensional workpieces are to be found, for example, in EP 2 961 549 A1 and in EP 2 878 402 A1.

The devices described in those documents each comprise a carrier, which can be lowered downwards layer by layer in the vertical direction. A corresponding vertical movement of the carrier takes place in these known devices whenever a layer of the raw material powder has been irradiated completely and before the next powder layer is applied. It can thus be ensured that a focal plane of the irradiation unit is always located in the layer of the raw material powder that is to be solidified (i.e. in the uppermost layer). During a build process, the workpiece is thus produced layer by layer in a build cylinder, wherein the depth of the build cylinder increases during the build process by the lowering of the baseplate, and a base area of the build cylinder specified by the surface of the carrier and by corresponding side walls of the build cylinder remains constant. The maximum volume of the build cylinder thus defines an upper limit for the maximum volume of a workpiece that is to be produced.

In the known devices described above, the vertical movability of the carrier requires actuating elements or a lifting mechanism. The lifting mechanism must support and move inter ala both the workpiece to be built up and the surrounding powder material. Depending on the size of the installation and the size of a corresponding build space (volume of the build cylinder), the lifting mechanism used may thereby reach its load limits, which would require a more complex and thus more expensive lifting mechanism. Furthermore, the weight to be moved by the lifting mechanism changes during the build process. This can have the result that the adjustment travel cannot be kept constant between two adjustment operations of the lifting mechanism, which results in undesirable deviations in the layer thickness of the raw material powder layers.

Accordingly, the object of the invention is to provide a solution for an additive layer building method which reduces or overcomes the above-mentioned problems and other problems associated therewith.

The object is achieved by a device having the features of patent claim 1 and a method having the features of patent claim 9.

Accordingly, the invention relates, according to a first aspect, to a device for producing three-dimensional workpieces. The device comprises a carrier for receiving raw material powder and an irradiation unit for selectively irradiating the raw material powder applied to the carrier with electromagnetic radiation or particle radiation, in order to produce on the carrier a workpiece manufactured from the raw material powder by an additive layer building method. The device further comprises a vertical movement device which is adapted to move the irradiation unit vertically with respect to the carrier, and a substantially vertically extending build cylinder wall which constitutes a lateral delimitation for the raw material powder applied to the carrier, wherein the build cylinder wall is adapted to increase its vertical height during a build process.

The carrier can thereby provide a horizontal surface to which the raw material powder can be applied layer by layer, that is to say in horizontal layers. The build cylinder wall can thereby serve to delimit a build cylinder at the sides. The term build cylinder is not to be understood in the present disclosure as meaning that a shape of the build cylinder is limited to the shape of a circular cylinder. Instead, a shape of the build cylinder can be a general cylinder having any desired base area. The build cylinder can have, for example—defined by the build cylinder wall—a round, elliptical, polygonal or rectangular (with or without rounded corners) cross-section, in particular a square cross-section. The build cylinder wall can constitute a lateral delimitation for the raw material powder applied to the carrier inasmuch as the build cylinder wall holds the raw material powder in shape and/or mechanically supports it at the sides. To that end, the raw material powder can directly adjoin the build cylinder wall. However, it is also possible, as described hereinbelow, to provide a build cylinder sleeve which extends between the raw material powder and the build cylinder wall so that the raw material powder does not directly adjoin the build cylinder wall but instead directly adjoins the build cylinder sleeve. The build cylinder sleeve can consist of a flexible material so that a lateral expansion of the flexible material by the build cylinder wall is prevented. In this case too, the raw material powder is thus held in shape by the build cylinder wall.

The build cylinder wall can be adapted to surround the raw material powder applied to the carrier completely at the sides and to hold the raw material powder in shape on all sides. “On all sides” here means that the build cylinder wall constitutes a barrier for the raw material powder in all horizontal directions.

The vertical height (also only “height” hereinbelow) of the build cylinder wall can here be defined as a height of the build cylinder wall which can be used as the build cylinder wall. In other words, the height can be defined as a height which can be used to delimit at the sides the raw material powder applied to the carrier. The vertical height of the build cylinder wall can also be defined, for example, as a vertical height of the build cylinder wall of a substantially vertically extending portion of the build cylinder wall. The substantially vertically extending portion can have regions which extend both above and beneath the carrier.

The term build cylinder is to be understood in the present disclosure as meaning a spatial region in which the application of the raw material powder layers takes place and which is delimited at the bottom by the carrier and at the sides by the build cylinder wall. Above the build cylinder there can follow a process chamber, which forms a space through which the beam of the irradiation unit is deflected in order to strike a desired point of the uppermost powder layer. Further elements of the device, such as, for example, a powder application device, can further be located in the process chamber.

Generally speaking, the device can comprise a powder application device which is adapted to apply the raw material powder to the carrier layer by layer. The powder application device can comprise a powder container and/or be connected to a powder reservoir, so that raw material powder can be fed to the powder application device. The powder application device can be adapted to travel over a previous powder layer in a horizontal direction and thereby apply a new powder layer. To that end, the powder application device can comprise at least one roller, pusher and/or similar suitable means for applying a raw material powder layer.

The process chamber, together with the build cylinder, can constitute a space which is closed in an air-tight manner. This space can be filled with an inert gas (for example argon or nitrogen) during the build process.

The build cylinder described herein can be a build cylinder having a substantially rectangular base area and having side lengths of, for example, in each case more than 50 cm. In other words, at least one of the two orthogonal side lengths of the carrier can be at least 50 cm. Furthermore, at least one of the two orthogonal side lengths of the carrier can be at least 100 cm. The carrier used herein can thus be, for example, a carrier having a base area of 1 m×1 m.

The irradiation unit can comprise at least one optical element. The optical element of the irradiation unit can be, for example, a scan unit, a focusing unit and/or an F-theta lens. The irradiation unit can further comprise a radiation source, such as, for example, an electron beam source or a laser. The radiation emitted by the irradiation unit can, however, also be supplied to the irradiation unit from a radiation source which is located outside the irradiation unit. Mirrors, optical fibers and/or other light guides, for example, can be used for this purpose.

The carrier can be connected in a stationary manner to a base of the device. The base of the device can comprise, for example, a baseplate of the device. The base can be adapted to be immovable after construction of the device and/or during operation of the device (he. during a build process). In particular, the base can be immovable with respect to a vertical direction. The term “immovable” here means immovability in relation to the surroundings in which the device is constructed.

The vertical movement device can comprise a lifting device, for example. The vertical movement device can comprise one or more hydraulic and/or mechanical actuators. During the vertical movement, the irradiation unit can be moved vertically together with the process chamber mentioned hereinbefore (i.e. together with a process chamber wall of the process chamber).

The device can further comprise a plurality of wall elements which are adapted to be detachably connected together so that, in a connected state, they form the substantially vertically extending cylinder wall.

The vertical height of the build cylinder wall can be defined by the sum of the vertical heights of the wall elements that are in the connected state.

An uppermost wall element of the build cylinder wall can be mechanically connected to a lower region of the process chamber and can be moved vertically together with the process chamber and the irradiation unit. For example, there can be provided a build cylinder wall that is permanently connected to the process chamber, to which further wall elements can be fastened from beneath during a build process.

The plurality of wall elements can be connected together, for example, by means of suitable connecting means. The connection is detachable in that it can be detached to again in a clearly defined manner without damaging the wall elements and/or any connecting means which may be provided. As connecting means there can be provided, for example, a plug-type connection, a snap-in connection, a screw, a thread, a bolt, another suitable connecting means and/or any desired combination of the above-mentioned means.

In the connected state, the wall elements that are connected together can form a continuous substantially vertical wall surface. The wall elements can be adapted to be connected together by hand or by means of a suitable connecting device.

The device can be adapted to carry out one of the methods described herein. In particular, the device can have a suitable control unit which is so programmed that it controls the device in such a manner that the device carries out one of the methods described herein. The control unit can comprise a processor (for example a CPU) and a memory.

The wall elements can be connected together in such a manner that, in the connected state, at least two of the wall elements are arranged one above the other in the vertical direction.

The wall elements can thereby have suitable vertical connecting means, by means of which they can be connected together in the vertical direction. The vertical connection can be carried out at boundary surfaces of the wall elements that extend substantially horizontally.

The wall elements can be connected together in such a manner that, in the connected state, at least two of the wall elements are arranged side by side in the horizontal direction.

The wall elements can thereby have suitable horizontal connecting means, by means of which they can be connected together in the horizontal direction. The horizontal connection can be carried out at boundary surfaces of the wall elements that extend substantially vertically.

The vertical movement device can be adapted to move the build cylinder wall vertically with respect to the carrier together with the irradiation unit.

To that end, the build cylinder wall in the connected state can be mechanically coupled with the irradiation unit. For example, the build cylinder wall can be connected to a process chamber, wherein the irradiation unit is also connected to the process chamber. In particular, the irradiation unit can be connected to an upper cover region of the process chamber, and the build cylinder wall can be connected to a lower bottom region of the process chamber wall, It is thereby possible, for example, for a portion of the build cylinder wall to be connected rigidly and non-detachably to the process chamber, wherein the further wall elements can be connected to that rigid portion of the build cylinder wall in order to form the build cylinder wall.

The device can further comprise a further vertical movement device which is adapted to move the build cylinder wall vertically with respect to the carrier.

The movement of the irradiation unit can thus be carried out independently of the movement of the build cylinder wall. However, the further vertical movement device can thereby be adapted to follow a movement of the irradiation unit, that is to say to carry out a vertical movement which corresponds to that of the vertical movement device of the irradiation unit.

The device can further comprise an inner build cylinder sleeve, wherein a lower edge of the build cylinder sleeve is connected to the carrier and an upper edge of the build cylinder sleeve can be moved vertically by the vertical movement device together with the irradiation unit, wherein the inner build cylinder sleeve is adapted to constitute, in the connected state of the wall elements, an inner wall for the raw material powder applied to the carrier, wherein the raw material powder directly adjoins the build cylinder sleeve.

The expressions “inner build cylinder sleeve” and “build cylinder sleeve” are used synonymously herein. The lower edge of the build cylinder sleeve can be fastened, for example, to an edge of the carrier. The upper edge of the build cylinder sleeve can be fastened, for example, to a lower bottom region of a process chamber of the device.

The material of the build cylinder sleeve can be impermeable to powder and, optionally, impermeable to gas (in particular impermeable to an inert gas that is used).

The inner build cylinder sleeve can comprise at least one of the following elements: a flexible sleeve of extensible material, a corrugated bellows, and/or a plurality of wall segments which are adapted to be stored nested one inside the other in a retracted state and to be deployed in the manner of a telescope into a deployed state.

The extensible material can comprise, for example, a flexible plastics and/or rubber material. The wall segments can in each case be substantially more thin-walled (e.g., not more than one quarter of the thickness) than the wall elements of the build cylinder wall.

The device can further comprise a connecting device which is adapted to connect the wall elements together during a build process.

The connecting device can comprise, for example, a robotic arm and/or other suitable means for connecting the wall elements together. The connecting device can be adapted to grip the wall elements and to fasten them from beneath to wall elements that are already connected (already in the connected state) during the build process. Any type of automated connection of the wall elements is thereby possible.

The device can further comprise a plurality of wall elements which are connected together by means of flexible connections, wherein a first portion of the wall elements is in a vertical state, wherein the wall elements of the first portion in the vertical state form the substantially vertically extending build cylinder wall, and wherein a second portion of the wall elements is in a rolled-up state, wherein the wall elements of the second portion in the rolled-up state do not form the substantially vertically extending build cylinder wall, and wherein the plurality of wall elements is so adapted that wall elements can be unrolled from the rolled-up state into the vertical state, so that the vertical height of the build cylinder wall is increased.

The vertical height of the build cylinder wall can be defined by the sum of the vertical heights of the wall elements that are in the vertical state.

The wall elements can be connected together in the form of a blind. During the build process, more and more wall elements can be unrolled into the vertical state, so that the height of the vertical wall increases. The wall elements in the rolled-up state can be situated beneath the carrier.

The build cylinder wall can be formed by a flexible wall of extensible material, wherein a lower edge of the flexible wall is connected to the carrier and an upper edge of the flexible wall can be moved vertically by the vertical movement device together with the irradiation unit.

With regard to the flexible wall, the comments made above in relation to the build cylinder sleeve apply, with the only difference that, for the flexible wall, it is not necessary to provide an additional build cylinder wall outside the flexible wall. The flexible wall can be in such a form that, although on the one hand it is sufficiently flexible in the vertical direction that it can be deformed in the vertical direction during the build process, it is less flexible in the horizontal direction so that it is able to hold the raw material powder in shape (for example in a cuboid shape). In other words, the flexible wall can be in such a form that it is easier to deform in the vertical direction than in the horizontal direction.

The device can further comprise a collecting tray for collecting raw material powder which trickles down from the carrier at the sides after completion of a build process and after the build cylinder wall has been at least partially lifted or removed, and a sealing device which is adapted to guide into the collecting tray the raw material powder which trickles down from the carrier at the sides. The sealing device can be in the form of a corrugated bellows, for example. The sealing device can be attached, for example, at a first end of the sealing device to an underside of the process chamber. The sealing device can further be fastened at a second end of the sealing device to the collecting tray. The sealing device can comprise a flexible material which allows a vertical height of the sealing device to be changed. The sealing device 3c can also be detachably connected to a lowermost wall element of the build cylinder wall.

According to a second aspect, the invention relates to a method for producing three-dimensional workpieces. The method comprises applying raw material powder to a carrier and selectively irradiating the raw material powder applied to the carrier with electromagnetic radiation or particle radiation by an irradiation unit in order to produce on the carrier a workpiece manufactured from the raw material powder by an additive layer building method. The method further comprises moving the irradiation unit vertically with respect to the carrier by means of a vertical movement device and increasing, during a build process, a vertical height of a substantially vertically extending build cylinder wall which constitutes a lateral delimitation for the raw material powder applied to the carrier.

The method can be carried out, for example, by one of the devices described herein. The steps of the method that are described herein can be carried out in any desired order—unless explicitly mentioned otherwise. In particular, the vertical movement step can be carried out before or after the increasing step. Furthermore, a plurality of increasing and/or vertical movement steps can also be provided. The increasing step can be carried out during a build process of the device. In other words, the increasing step can be performed when a workpiece to be produced has been partially but not yet completely manufactured, that is to say not all the powder layers required for the workpiece have yet been applied and solidified.

The increasing step can further comprise detachably connecting a plurality of wall elements together so that, in a connected state, they form the substantially vertically extending build cylinder wall.

The method can further comprise detachably connecting at least one further wall element to an underside of at least one of the wall elements forming the build cylinder wall and moving the build cylinder wall vertically upwards.

At least two (or more) wall elements can thus be connected together, and in particular connected together one above the other, in order to form the build cylinder wall.

The wall elements can be connected together in such a manner that, in the connected state, at least two of the wall elements are arranged one above the other in the vertical direction. The wall elements can further be connected together in such a manner that, in the connected state, at least two of the wall elements are arranged side by side in the horizontal direction.

The build cylinder wall can be moved vertically together with the irradiation unit with respect to the carrier by the vertical movement device.

The build cylinder wall can be moved vertically with respect to the carrier by a further vertical movement device.

The method can further comprise removing at least one of the wall elements, wherein the removed wall element is one of the lowermost wall elements of the build cylinder wall, so that raw material powder is able to trickle down from the carrier at the sides.

The removing step can be carried out once a build process has taken place. In particular, the removing step can be carried out as the beginning of an “unpacking process” of the finished workpiece.

The method can further comprise moving the build cylinder wall vertically upwards, so that a gap forms between a lowermost wall element of the build cylinder wall and the carrier, through which gap raw material powder is able to trickle down from the carrier at the sides.

The step of moving vertically upwards can be carried out once a build process has taken place. In particular, the step of moving vertically upwards can be carried out as the beginning of an “unpacking process” of the finished workpiece.

After the above-mentioned removing step or after the above-mentioned step of moving vertically upwards, the previously connected wall elements can be removed (detached) again, the irradiation unit can (optionally together with the process chamber) be moved (downwards) into a starting state again, and a new build process can be begun.

There can further be provided a plurality of wall elements which are connected together by means of flexible connections, wherein a first portion of the wall elements is in a vertical state, wherein the wall elements of the first portion in the vertical state form the substantially vertically extending build cylinder wall, and wherein a second portion of the wall elements is in a rolled-up state, wherein the wall elements of the second portion in the rolled-up state do not form the substantially vertically extending build cylinder wall. The method can here further comprise unrolling wall elements from the rolled-up state into the vertical state, so that the vertical height of the build cylinder wall is increased.

The build cylinder wall can further be formed of a flexible wall of extensible material, wherein a lower edge of the flexible wall is connected to the carrier. The method can here further comprise vertically moving an upper edge of the flexible wall together with the irradiation unit by the vertical movement device.

The method can further comprise collecting in a collecting tray the raw material powder which trickles down, and guiding the raw material powder which trickles down into the collecting tray by means of a sealing device. The method can further comprise fastening one end of the sealing device to an underside of the process chamber or to a lowermost wall element of the build cylinder wall. The sealing device can here be adapted not only to guide raw material powder but also to prevent raw material powder dust from being released into the environment of the device 1,

The invention will be explained in greater detail hereinbelow with reference to the accompanying figures, in which:

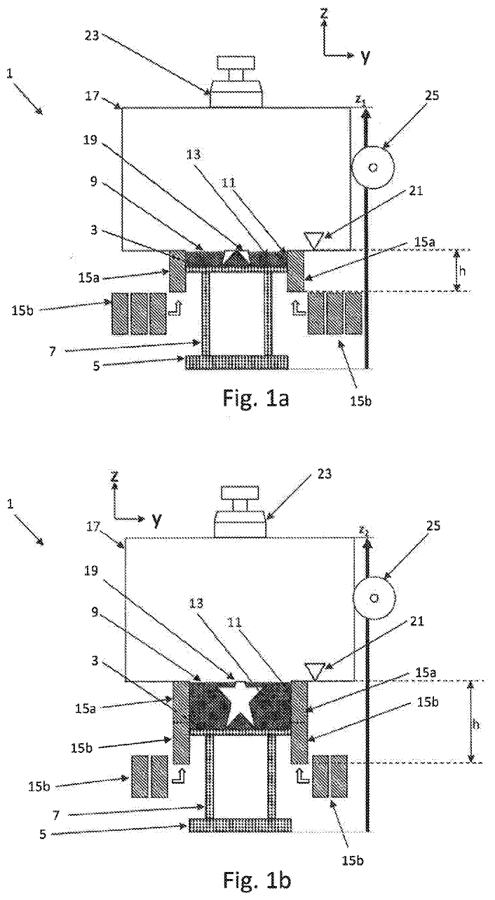

FIG. 1a: is a schematic side view of a first exemplary embodiment of a device according to the invention which carries out a method according to the invention;

FIG. 1b: is a schematic side view of the first exemplary embodiment at a later point in time of the method according to the invention;

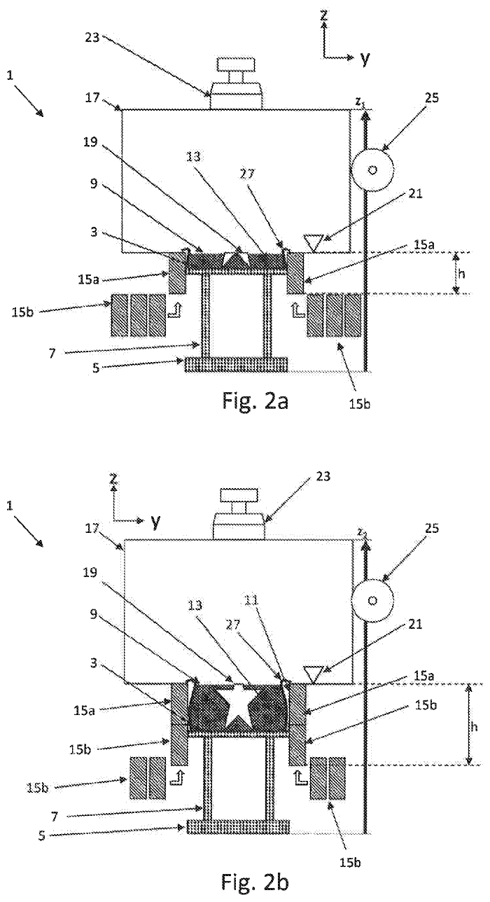

FIG. 2a: is a schematic side view of a second exemplary embodiment of a device according to the invention which carries out a method according to the invention;

FIG. 2b: is a schematic side view of the second exemplary embodiment at a later point in time of the method according to the invention;

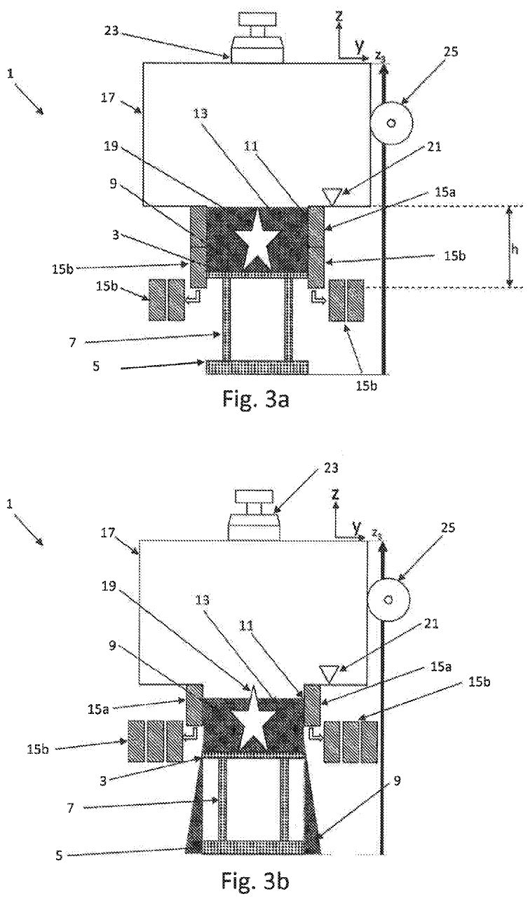

FIG. 3a: is a schematic side view of the first exemplary embodiment at a point in time after the point in time shown in FIG. 1b of the method according to the invention;

FIG. 3b: is a schematic side view of the first exemplary embodiment at a point in time after the point in time shown in FIG. 3a of the method according to the invention;

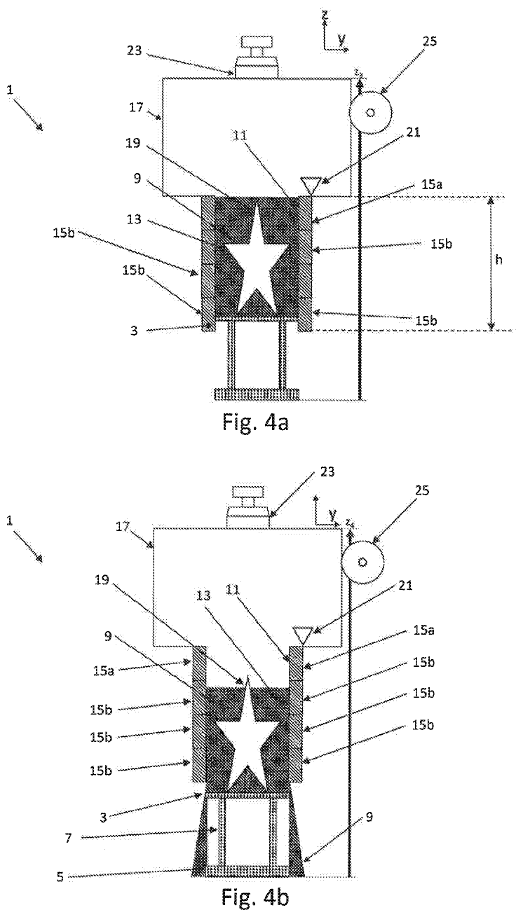

FIG. 4a: is a schematic side view of the first exemplary embodiment at a point in time after the point in time shown in FIG. 1b of an alternative method according to the invention;

FIG. 4b: is a schematic side view of the first exemplary embodiment at a point in time after the point in time shown in FIG. 4a of the alternative method according to the invention;

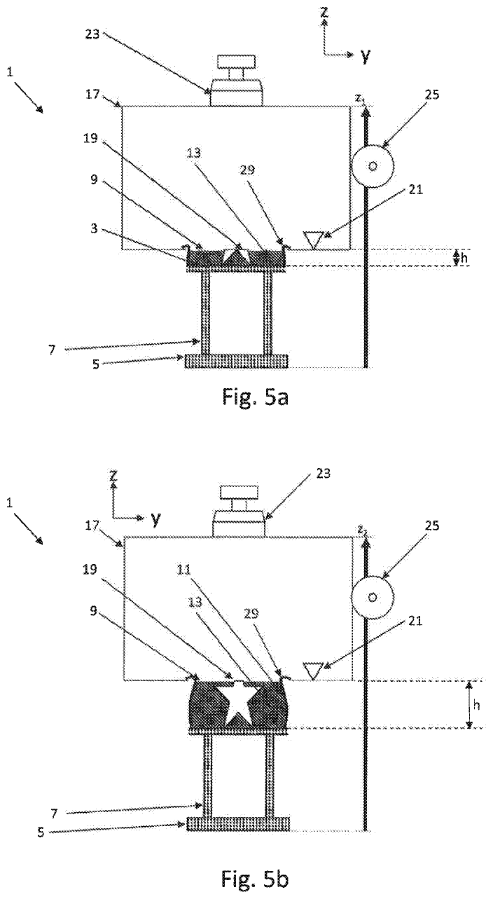

FIG. 5a: is a schematic side view of a third exemplary embodiment of a device according to the invention which carries out a method according to the invention;

FIG. 5b: is a schematic side view of the third exemplary embodiment at a later point in time of the method according to the invention;

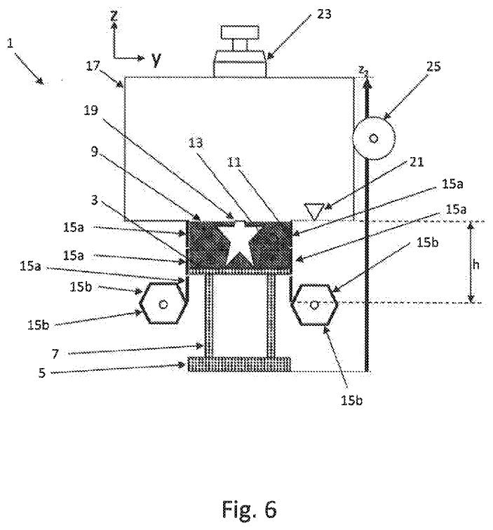

FIG. 6: is a schematic side view of a fourth exemplary embodiment of a device according to the invention which carries out a method according to the invention;

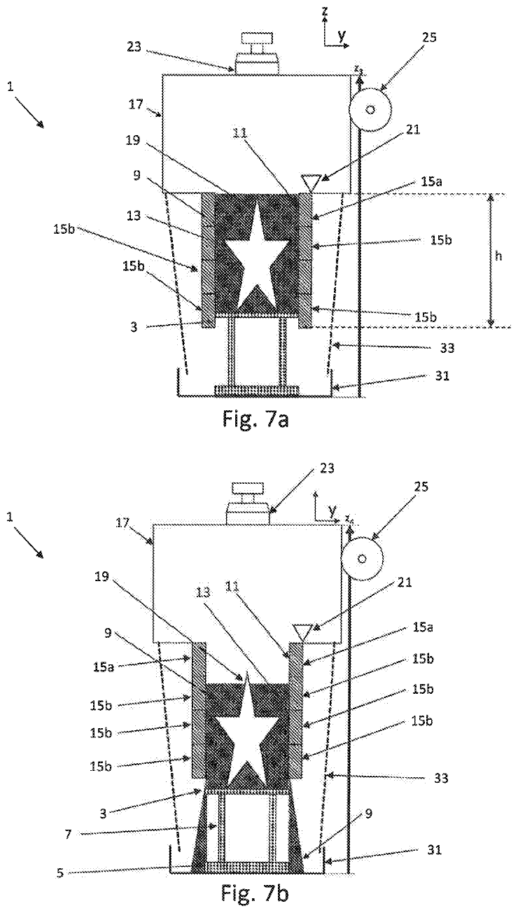

FIG. 7a: is a schematic side view of a modification of the first exemplary embodiment; and

FIG. 7b: is a schematic side view of the modification according to FIG. 7a at a point in time after the point in time shown in FIG. 7a.

FIGS. 1a and 1b show a first exemplary embodiment of a device 1 according to the invention in a schematic side view. The views of the figures are not necessarily true to scale. A vertical direction is defined in the figure by the z-direction and a horizontal plane (also x-y plane hereinbelow) extends perpendicularly to the plane of the drawing along a carrier 3 of the device 1.

The device 1 comprises a stationary base 5, which is connected in a stationary manner to a baseplate (not shown) of the device 1 or itself constitutes a baseplate of the device 1. The device 1 can further have an outer housing (not shown) with outside walls and an outside cover. The device 1 can, however, also be provided without its own outer housing in an open construction, for example in a factory building.

The device 1 further comprises the carrier 3, which is permanently connected to the base 5 and which has a horizontal rectangular surface. In the exemplary embodiment of the figures, the carrier 3, by means of supporting elements 7, is provided at a predetermined distance (i.e. at a predetermined height in the z-direction) relative to the base 5 and is fastened thereto. The carrier 3 is adapted to receive a plurality of layers of raw material powder 9. The carrier 3 is adjoined at the sides by a build cylinder wall 11, which encloses the carrier 3 completely at the sides. Both the carrier 3 and the build cylinder wall 11 thus have a rectangular cross-section, when seen in a plan view. The build cylinder wall 11 encloses the carrier 3 at the sides in such a manner that it adjoins the raw material powder 9 located on the carrier 3, supports it at the sides and holds it in a cuboid shape.

The build cylinder wall 11 defines a build cylinder 13 located within the build cylinder wall 11. The build cylinder 13 is delimited at the bottom by the carrier 3 and at the sides by the build cylinder wall 11. The build cylinder wall 11 is formed by first wall elements 15a, which are fastened to an underside, or a lower bottom region, of a process chamber 17 of the device 1. The first wall elements 15a can either be detachably connected to the process chamber 17 or rigidly and non-detachably connected to the process chamber 17. There are further provided further wall elements 15b which can be connected to the wall elements 15a, as will be described hereinbelow in connection with FIG. 1b.

A vertical height h of the build cylinder wall 11 is here defined as a vertical height h of the build cylinder wall 11 of a substantially vertically extending portion of the build cylinder wall 11. The substantially vertically extending portion thereby has regions which extend both above and beneath the carrier 3. In the representation of FIG. 1a, for example, only one layer of first wall elements 15a is provided, wherein the height h of the build cylinder wall in this state is formed by a vertical height of those first wall elements 15a.

The process chamber 17 and the build cylinder 13 together form a space which can be sealed in an air-tight manner and can be filled with an inert gas (such as, for example, nitrogen or argon). However, air-tight sealing to the top is not absolutely necessary, for example, in the case of the use of argon as protecting gas, since argon, because of its high density, accumulates in the region of the build cylinder 13 (that is to say in the region of the raw material powder 9) and cannot escape upwards. In the process chamber 17 and the build cylinder 13, a process of building a workpiece 19 by means of an additive layer building method takes place.

The device 1 further has a powder application device 21, by means of which the raw material powder 9 can be applied layer by layer to the carrier 3. To that end, the powder application device 21 can comprise at least one roller, at least one pusher and/or other suitable powder application means, which are suitable for applying to the carrier 3, or to a previous raw material layer, a raw material powder layer that is as uniformly thick as possible. The powder application device 21 is connected to a raw material powder reservoir (not shown), in order to be supplied with raw material powder 9 from the reservoir.

The device 1 further has an irradiation unit 23 for selectively irradiating the raw material powder 9 applied layer by layer to the carrier 3. The irradiation unit 23 is permanently connected to the process chamber 17 in an upper cover region of the process chamber. By means of the irradiation unit 23, the raw material powder 9 can be exposed to location-specific radiation, in dependence on the desired geometry of the workpiece 19 to be produced. To that end, the irradiation unit 23 has a radiation source, which can be provided in the form of a laser. The laser can, for example, emit light at a wavelength of approximately 1064 nm. Alternatively, the radiation source (for example a laser) can also be located outside the irradiation unit 23 and a beam to be directed onto the raw material powder 9 is fed to the irradiation unit 23, for example, by means of an optical fiber.

The irradiation unit 23 further has optical elements, such as, for example, a scan unit, a focusing unit and an F-theta lens. The scan unit is adapted to scan the beam over the uppermost raw material powder layer within a horizontal plane (in the x-direction and y-direction). The focusing unit is adapted to change or adapt a focus position of the beam (in the z-direction), so that a focal plane of the irradiation unit 23 is located in the region of the uppermost raw material powder layer, which is irradiated by the irradiation unit 23. The irradiation unit 23 can be, for example, an irradiation unit or irradiation device as described in EP 2 333 848 B1.

The device 1 further has a vertical movement device 25 which is adapted to move the irradiation unit 23 in the vertical direction (z-direction) relative to the carrier 3. As is shown in FIG. 1a, the irradiation unit 23 and the first wall elements 15a are connected to the process chamber 17, so that the vertical movement device is able to move the process chamber 17 vertically upwards and downwards together with the irradiation unit 23 and the first wall elements 15a. In other words, the irradiation unit 23 and the first wall elements 15a are so connected to the process chamber 17 that a vertical movement of the process chamber 17 leads to a vertical movement of the irradiation unit 23 and of the first wall elements 15a relative to the carrier 3 and thus relative to the base 5.

Furthermore, the powder application device 21 is so connected to the process chamber 17 that a vertical movement of the process chamber 17, or of the irradiation unit 23, leads to a vertical movement of the powder application device 21. For the powder application device 21 there is provided a horizontal movement device (not shown), by means of which the powder application device 21 can be moved over the carrier 3 in the horizontal direction in order to apply the raw material powder 9.

The vertical movement device 25 of the device 1 shown in FIG. 1a comprises a motor, which can be, for example, a step motor or servomotor. The vertical movement device 25 can, however, also be configured in many different ways and can comprise, for example, any type of actuating elements or lifting device. For example, the vertical movement device 25 can have a hydraulic and/or mechanical actuator. The vertical movement device 25 can have, for example, a spindle shaft and a motor that drives the spindle shaft.

By means of the vertical movement device 25, a vertical distance between the irradiation unit 23 and the carrier 3 can be changed. In particular, that distance can be so changed that a distance between the irradiation unit 23 and the uppermost layer of the raw material powder 9 always remains constant. The vertical movement of the process chamber 17 effected by the vertical movement device 25 takes place together with the first wall elements 15a (and optionally further wall elements 15b) and thus together with the build cylinder wall 11. This means in particular that the build cylinder wall 11 is also moved by the vertical movement device 25.

The device 1 further comprises a control unit (not shown) which is adapted to control the vertical movement device 25. The control unit comprises a CPU and a memory, wherein a program is stored in the memory, which program, when executed by the CPU, causes the device 1 to carry out one of the methods described herein. The control unit can further take over all the control tasks of the device 1 and, for example, control the irradiation unit 23 (and optical elements contained therein) and the powder application device 21.

A build process of the device 1 will be explained hereinbelow with reference to FIGS. 1a and 1b. The build process takes place in such a manner and is controlled by the control unit in such a manner that the vertical movement device 25 moves the powder application device 21 (together with the process chamber 17 and the irradiation unit 23) so far into a starting state that the powder application device 21 can apply a first raw material powder layer to the carrier 3. Alternatively, the irradiation unit 23, the process chamber 17 and the first wall elements 15a can already be in that starting state. Subsequently or simultaneously, the vertical movement device 25 moves the irradiation unit 23—if necessary—to a height which is suitable for selectively irradiating that first raw material powder layer and solidifying it (for example by fusion or sintering). The scan unit thereby scans the beam over the raw material powder 9 in accordance with a predetermined pattern. Once the first raw material powder layer has been irradiated as desired, the vertical movement device 25 moves the powder application device 21 to a height at which it can apply a second raw material powder layer to the first raw material powder layer. An operation of irradiating the second raw material powder layer then takes place, analogously to the irradiation of the first raw material powder layer.

During the build process for the desired workpiece 19, the vertical movement device 25 thus moves the irradiation unit 23 (and the process chamber 17 together with the powder application device 21 and first wall elements 15a) upwards (in the positive z-direction) increasingly further away from the carrier 3.

In FIG. 1a, the device 1 is shown, for example, in a situation during the build process in which the irradiation unit 23 is at a first height zi (relative to an underside of the base 5, or relative to a baseplate of the device 1). As the build process continues, a depth of the build cylinder 13 increases and increasingly longer build cylinder walls 11 are necessary to prevent the raw material powder 9 from trickling down from the carrier 3 in an uncontrolled manner. Thus, when the length (in the z-direction) of the first wall elements 15a is no longer sufficient, further wall elements 15b are fastened to the first wall elements 15a from beneath. In other words, further wall elements 15b are fastened from beneath to wall elements 15a, 15b that are already present (wall elements in the connected state) when, or shortly before, an overall depth (in the z-direction) of the powder layers has reached an overall length (in the z-direction) of the wall elements 15a, 15b that are present.

FIG. 1b shows, for example, a situation at a later point in time than the situation shown in FIG. 1a, wherein the irradiation unit 23 is at a second height z2 which is greater than the first height zl of FIG. 1a. In this state, the first wall elements 15a are no longer sufficient and further wall elements 15b have been fastened to the first wall elements 15a from beneath, so that the wall elements 15a and 15b are in a connected state and so that those wall elements 15a, 15b together form a build cylinder wall 11.

The height h of the build cylinder wall 11 is greater in FIG. 1b than in FIG. 1a. At the point in time of FIG. 1b, two layers of first wall elements 15a are in a connected state. The height h is thereby defined by the sum of the vertical heights of the wall elements 15a in the connected state. In the case of FIG. 1b, the height h thus corresponds to the sum of the vertical heights of two wall elements 15a.

In a preferred embodiment, sealing between the individual wall elements 15a, 15b can be achieved by means of an internal hose structure resting on the wall elements 15a, 15b. In this manner, raw material powder 9 can be prevented from trickling down and wear of the wall elements 15a, 15b by raw material powder 9 can be prevented, and the inert gas atmosphere can be kept stable.

For connecting the wall elements 15a, 15b, the wall elements can have corresponding connecting means which are suitable for ensuring a detachable connection of the wall elements 15a, 15b. The connecting means are further in such a form that, in the connected state of the wall elements 15a, 15b, there can be provided a substantially vertical build cylinder wall 11 that is as continuous as possible. The wall elements 15a, 15b can comprise, for example, connecting means in the form of plug-type connections, screws and associated threads, bolts and associated openings, hooks and associated eyes, etc. An operation of connecting the wall elements 15a, 15b can be carried out manually by an operator of the device 1 during the build process. Alternatively, a connecting device (not shown) can be provided, which connecting device is adapted to connect the individual wall elements 15a, 15b to one another. The connecting device can comprise, for example, at least one robotic arm or another suitable element for connecting the wall elements 15a, 15b.

The wall elements 15a, 15b can be in such a form, for example, that, in a plane parallel to the carrier 3 (that is to say in a layer of wall elements 15a, 15b), in each case exactly one wall element 15a, 15b is provided for each side of the rectangular carrier 3. Thus, the first wall elements 15a can comprise four wall elements 15a, each of which adjoins a side edge of the carrier 3. If a longer build cylinder wall 11 is required (see FIG. 1b), a second wall element 15b for each of the four first wall elements 15a can be fastened beneath the respective first wall element 15a by means of vertical connecting means. Furthermore, horizontal connecting means can be provided for connecting the wall elements 15b of a layer of wall elements 15b together horizontally. A horizontal connection of the wall elements 15b can take place, for example, in a corner region of the build cylinder wall 11, where the individual wall elements 15b adjoin one another perpendicularly.

The wall elements 15a, 15b can in particular be plate-shaped and substantially rectangular, wherein vertical and optionally horizontal connecting means are provided at lateral edge regions of the wall elements 15a, 15b.

FIGS. 2a and 2b show a second exemplary embodiment of a device 1 according to the invention in a schematic side view. The second exemplary embodiment is modified only slightly relative to the first exemplary embodiment, so that a description of the identical features of the two exemplary embodiments will not be repeated. Features which are identified by the same reference numerals fulfill the same function as described in relation to the first exemplary embodiment.

In a departure from the device of the first exemplary embodiment, the device 1 of the second exemplary embodiment additionally has an inner build cylinder sleeve 27. The build cylinder sleeve 27 is arranged between the build cylinder wall 11 of the wall elements 15a, 15b and the raw material powder 9, so that the raw material powder 9 directly adjoins the build cylinder sleeve 27 but does not directly adjoin the build cylinder wall 11.

As is shown in FIGS. 2a and 2b, a lower edge of the build cylinder sleeve 27 is connected to the carrier 3, and an upper edge of the build cylinder sleeve 27 is moved vertically by the vertical movement device 25 together with the irradiation unit 23. The lower edge of the build cylinder sleeve 27 is fastened to an edge of the carrier 3. The upper edge of the build cylinder sleeve 27 is fastened to a lower bottom region of the process chamber 17. The material of the build cylinder sleeve 27 is impermeable to powder, in order to prevent the raw material powder 9 from coming into direct contact with the build cylinder wall 11. The build cylinder sleeve 27 can further be impermeable to the inert gas, in order to maintain the inert gas atmosphere within the build cylinder 17.

When the build cylinder sleeve 27 is additionally provided, as shown in FIGS. 2a and 2b, wear of the build cylinder wall 11 by the raw material powder 9 can be avoided on the one hand. On the other hand, the wall elements 15a, 15b, and in particular the connection points between the wall elements 15a, 15b, do not have to be so tightly sealed (with respect to penetration of powder and/or gas) as in the case of FIGS. 1a and 1b, in which the raw material powder 9 directly adjoins the wall elements 15a, 15b.

In the example of FIGS. 2a and 2b, the inner build cylinder sleeve 27 consists of a flexible sleeve of extensible material. The extensible material can comprise, for example, a flexible plastics and/or rubber material, Alternatively, however, it is also possible to provide a corrugated bellows or a plurality of wall segments which are adapted to be stored nested one inside the other in a retracted state and to be deployed in the manner of a telescope into a deployed state.

Owing to the extensibility of the build cylinder sleeve 27, it is able to expand in the z-direction during the build process as the distance between the process chamber 17 and the carrier 3 increases (see FIG. 2b). Any expansion in the x- and y-direction associated with the extensibility is taken up by the wall elements 15a, 15b, and the build cylinder 13 is thus stabilized.

A build process of the device I according to the second exemplary embodiment takes place similarly to the build process of the device 1 according to the first exemplary embodiment, wherein further wall elements 15b can, if required, be fastened from beneath to wall elements 15a, 15b that are already present (see FIG. 2b).

FIGS. 3a and 3b show the device 1 of the first exemplary embodiment after completion of the build process of the workpiece 19. FIGS. 3a and 3b show a first possibility for separating the workpiece 19 from the raw material powder 9 (so-called unpacking). FIGS. 3a and 3b thus describe steps of a method according to the invention which can be carried out with a device 1 according to the invention.

FIG. 3a shows the device 1 in a state in which the irradiation unit 23 has been moved by the vertical movement device 25 to a third height z3. The third height z3 is greater than the second height z2 shown in FIG. 1b. The workpiece 19 is thereby in a finished state. As is shown by way of example in FIG. 3a, a layer of further wall elements 15b has been fastened to the first wall elements 15a during the build process. It is of course further possible that a plurality of layers of wall elements 15b have been connected together during the build process.

As is shown in FIG. 3b, these wall elements 15b are then removed again in the reverse order (from beneath). This takes place while the irradiation unit 23, or the process chamber 17, remains at the same height z3. Since the process chamber wall 11 is hereby dismantled from beneath, the raw material powder 9 located on the carrier 3 is able to trickle down from the carrier 3 at the sides. After a lowermost wall element 15b has been removed, the further wall elements 15a, 15b located above the lowermost wall element 15b can be removed until as much powder as possible has been able to trickle down from the carrier 3. Furthermore, in some exemplary embodiments, the workpiece 19 can be removed at the side in this state, before it is completely freed of excess raw material powder 9. Alternatively, however, it is also possible to remove the carrier 3 together with the workpiece 19 located thereon (and any remaining residual raw material powder 9).

In particular, it is also possible in some exemplary embodiments to detach the first wall elements 15a from the process chamber 17. In other exemplary embodiments, however, the first wall elements 15a can also be permanently connected to the process chamber 17.

Once the raw material powder 9 and the workpiece 19 have been removed from the carrier 3, the vertical movement device 25 can move the process chamber 17 and the elements fastened thereto downwards again, and a new build process can be begun (see FIGS. 1a and 1b).

FIGS. 4a and 4b show the device 1 of the first exemplary embodiment after completion of the build process of the workpiece 19. FIGS. 4a and 4b show a second possibility for separating the workpiece 19 from the raw material powder 9 (so-called unpacking). FIGS. 4a and 4b thus describe steps of an alternative method according to the invention which can be carried out with a device 1 according to the invention.

In the representation of FIG. 4a, the irradiation unit 23, after completion of a build process of the workpiece 19, is situated at a third height z3, similarly to the representation of FIG. 3a, wherein the height z3 of FIG. 4a does not have to correspond to the height z3 of FIG. 3a. By way of example, it is shown in FIG. 4a that three layers of further wall elements 15b have been fitted beneath the first wall elements 15a during the build process. However, it is also possible for more or fewer wall elements 15b to have been fitted, depending on a height of the workpiece 19 and depending on a height of the wall elements 15b in question.

As is shown in FIG. 4b, after completion of the build process, the vertical movement device 25 can move the process chamber 17 together with the wall elements 15a, 15b fastened thereto upwards to a fourth height z4, so that a gap forms between the lowermost wall elements 15b of the build cylinder wall 11 and the carrier 3, through which gap raw material powder 9 is able to trickle down from the carrier 3 at the sides. By further lifting the wall elements 15a, 15b, the gap can be enlarged, optionally until the workpiece 19 can be removed from the carrier 3 at the side.

The process chamber 17 is then lowered into a starting state again and a new build process can be begun. The previously fitted wall elements 15b are thereby removed upwards again from beneath either before or after the process chamber 17 is lowered.

The method of FIGS. 3a/3b and the method of FIGS. 4a/4b can on the one hand be carried out, as described above, by the device 1 of the first exemplary embodiment of FIGS. 1a/1b. However, these methods can also be carried out by the device 1 of the second exemplary embodiment of FIGS. 2a/2b if the build cylinder sleeve 27 has previously been detached from the carrier 3 and/or from the process chamber 17 or has been removed completely. After detachment or removal of the build cylinder sleeve 27, the method can be carried out as described above and as shown in FIGS. 3a/3b or 4a /4b.

FIGS. 5a and 5b show a third exemplary embodiment of a device 1 according to the invention in a schematic side view, The third exemplary embodiment is modified only slightly relative to the second exemplary embodiment, so that a description of the identical features of the two exemplary embodiments will not be repeated. Features which are identified by the same reference numerals fulfill the same function as described in relation to the second exemplary embodiment.

In a departure from the device of the second exemplary embodiment, the device 1 of the third exemplary embodiment does not have wall elements. Instead, the build cylinder wall 11 is formed according to the third exemplary embodiment by a flexible wall 29 of extensible material. The flexible wall 29 is configured and fastened in a similar manner to the build cylinder sleeve 27 of the second exemplary embodiment. The flexible wall 29 is so provided that the raw material powder 9 directly adjoins the flexible wall 29.

As is shown in FIGS. 5a and 5b, a lower edge of the flexible wall 29 is connected to the carrier 3, and an upper edge of the flexible wall 29 is moved vertically by the vertical movement device 25 together with the irradiation unit 23. The lower edge of the flexible wall 29 is fastened to an edge of the carrier 3. The upper edge of the flexible wall is fastened to a lower bottom region of the process chamber 17. The material of the flexible wall 29 is impermeable to powder, in order to prevent the raw material powder 9 from penetrating the build cylinder wall 11. The flexible wall 29 can further be impermeable to the inert gas, in order to maintain the inert gas atmosphere within the build cylinder 17.

The flexible wall 29 consists of an extensible material. The extensible material can comprise, for example, a flexible plastics and/or rubber material. Owing to the extensibility of the flexible wall 29, it is able to expand in the z-direction during the build process as the distance between the process chamber 17 and the carrier 3 increases (see FIG. 5b). Any expansion in the x- and y-direction associated with the extensibility is here as small as possible. In particular, the flexible wall 29 can be in such a form that the extensibility has a preferential direction (vertical direction or z-direction). In other words, the flexible wall 29 can be in such a form that it can be expanded more readily (that is to say with a lower force application) in the z-direction than in the x- and y-direction.

A build process of the device 1 according to the second exemplary embodiment takes place similarly to the build process of the device 1 according to the second exemplary embodiment, but further wall elements do not have to be fastened to wall elements that are already present because the build cylinder wall 11 is provided by the flexible wall 29. During the build process, a height h of the build cylinder wall 11 increases. The height h is thereby defined as a vertical height h of the flexible wall 29 between a lower fastening position and an upper fastening position of the flexible wall 29. For example, the height h between a surface of the carrier 3 and an underside of the process chamber 17 can be measured.

FIG. 6 shows a fourth exemplary embodiment of a device 1 according to the invention in a schematic side view. The fourth exemplary embodiment is modified only slightly relative to the first exemplary embodiment, so that a description of the identical features of the two exemplary embodiments will not be repeated. Features which are identified by the same reference numerals fulfill the same function as described in relation to the first exemplary embodiment.

In a departure from the device of the first exemplary embodiment, the device 1 of the third exemplary embodiment does not have detachably connectable wall elements. Instead, the wall elements 15a and 15b of the device 1 of the fourth exemplary embodiment are connected together by means of flexible connections (not shown).

A first portion of the wall elements (wall elements 15a) is thereby in a vertical state and in this vertical state forms the substantially vertically extending build cylinder wall 11. A second portion of the wall elements (wall elements 15b) is in a rolled-up state and in this rolled-up state does not form the build cylinder wall 11. As is shown in FIG. 6, the wall elements 15b in the rolled-up state are rolled or wound on a roller. The wall elements 15b can be unrolled from the rolled-up state into the vertical state if required, so that the vertical height h of the build cylinder wall 11 is increased.

In the fourth exemplary embodiment, the vertical height h is given as the sum of the vertical heights of the wall elements 15a in the vertical state. This height h can be increased if required by unrolling the wall elements 15b.

As is shown in FIG. 6, an uppermost wall element 15a of the wall elements 15a in the vertical state can be moved vertically by the vertical movement device 25 together with the irradiation unit 23. This uppermost wall element 15a is hereby fastened to a lower bottom region of the process chamber 17. At the same time, the rollers having the wall regions 15b in the rolled-up state are rotated in this movement operation, so that further wall elements 15a, 15b can be unrolled from the roll. In other words, wall elements 15b are hereby transferred from a rolled-up state into a vertical state.

A build process of the device 1 according to the fourth exemplary embodiment takes place similarly to the build process of the device 1 according to the first exemplary embodiment but, instead of connecting further wall elements, in the exemplary embodiment of FIG. 6 further wall elements can automatically be unwound or unrolled from the rolled-up state from beneath. During the build process, a height h of the build cylinder wall 11 thus increases.

FIGS. 7a and 7b show a modification of the first exemplary embodiment of FIGS. 4a and 4b. All the elements shown in FIGS. 7a and 7b correspond to the elements of FIGS. 4a and 4b, or of FIGS. 1a and 1b, with the same reference numerals. In addition to the first exemplary embodiment of FIGS. 4a and 4b, the device 1 of the modification comprises a collecting tray 31 and a sealing device 33. The collecting tray 31 and the sealing device 33 are so arranged that the sealing device 33 guides into the collecting tray 31 the raw material powder 9 which trickles down from the carrier 3 at the sides at the point in time shown in FIG. 7b.

In the representation of FIGS. 7a and 7b, the base 5 of the device stands inside the collecting tray 31. Alternatively, the collecting tray can extend, for example, annularly around the base 5. Furthermore, a plurality of collecting trays 31 can be provided on a plurality of sides of the base 5. For example, four collecting trays 31 can be provided on the four sides of a rectangular base 5.

Furthermore, in the representation of FIGS. 7a and 7b, a first end (upper end) of the sealing device 33 is attached to the underside of the process chamber 17. The fastening can thereby be detachable or non-detachable. A second end (lower end) of the sealing device 33 is fastened to the collecting tray 31, so that the sealing device 33 extends, for example, in the form of a hose between the collecting tray 31 and the process chamber 17. The sealing device 33 is made of flexible material (for example in the form of a corrugated bellows), so that the vertical height of the sealing device 33 can change as the vertical movement device 25 moves.

As an alternative to attaching the first end of the sealing device 33 to the underside of the process chamber 17, it can also be attached to an underside of a lowermost wall element 15b. This connection can be detachable, for example, so that the sealing device 33 is fastened to one or more of the lowermost wall elements 15b only after the build process is complete.

The sealing device 33 is shown only by way of example in connection with the first exemplary embodiment of FIGS. 1a and 1b or 7a and 7b. A sealing device 33 and a collecting tray 31 can, however, also be used in a similar manner with each of the further exemplary embodiments described herein. According to FIGS. 2a and 2b, the device 1 comprises an inner build cylinder sleeve 27. A sealing device 33 can also be provided in connection with this exemplary embodiment, in order to collect in a collecting tray 31 raw material powder 9 which trickles down from the carrier 3 after the build cylinder sleeve 27 has been at least partially removed. The same applies to the flexible wall 29 according to the exemplary embodiment of FIGS. 5a and 5b. According to FIGS. 3a and 3b, the lowermost wall elements 3b are removed on completion of the build process. In this case too, a sealing device 33 can correspondingly guide into a collecting tray 31 the raw material powder 9 which trickles down. Furthermore, in the exemplary embodiment of FIG. 6 too, a sealing device 33 can be provided, wherein, on completion of the build process, one or more of the wall elements 15a, 15b can be detached so that the raw material powder 9 is able to trickle down at the sides and is guided by the sealing device 33 into a collecting tray 31.

The following applies to all the exemplary embodiments described herein. The device 1 is in each case shown only in a side view, so that the device 1, and in particular the build cylinder 13 with its build cylinder wall 11, is shown only two-dimensionally. The person skilled in the art will recognize that the build cylinder is also delimited in a direction perpendicular to the plane of the drawing and that the build cylinder wall 11 is provided in that region too. Concretely, this means, for example, for the first and second exemplary embodiment that wall elements 15a, 15b, and optionally a build cylinder sleeve 27, are also provided for delimitation perpendicularly to the plane of the drawing. For the fourth exemplary embodiment, this means that wall elements 15a, 15b which can be rolled up are also provided for delimitation perpendicularly to the plane of the drawing.

By providing a build cylinder wall 11 whose height h can be increased during a build process, a build cylinder 13 of theoretically infinite height can be achieved, and very large workpieces 19 (i.e. workpieces 19 of very great height with a large extent in the z-direction) can be produced. The technology of the present disclosure is thus flexible, modular and permits the production of a very large workpiece 19 by means of a device which does not have to permanently (for example not at the beginning of the build process) provide a correspondingly dimensioned build cylinder. Inter alia, a compact construction of the device 1 can thus be achieved.

1-17. (canceled)

18. A device for producing three-dimensional workpieces, comprising:
a carrier for receiving raw material powder;
an irradiation unit for selectively irradiating the raw material powder applied to the carrier with electromagnetic radiation or particle radiation, in order to produce on the carrier a workpiece manufactured from the raw material powder by an additive layer building method;
a vertical movement device which is adapted to move the irradiation unit vertically with respect to the carrier; and
a substantially vertically extending build cylinder wall which constitutes a lateral delimitation for the raw material powder applied to the carrier, wherein the build cylinder wall is adapted to increase its vertical height during a build process.

19. The device as claimed in claim 18, further comprising a plurality of wall elements which are adapted to be detachably connected together so that, in a connected state, they form the substantially vertically extending build cylinder wall.

20. The device as claimed in claim 19, wherein the wall elements can be connected together in such a manner that, in the connected state, at least two of the wall elements are arranged one above the other in the vertical direction.

21. The device as claimed in claim 19, wherein the wall elements can be connected together in such a manner that, in the connected state, at least two of the wall elements are arranged side by side in the horizontal direction.

22. The device as claimed in claim 19, wherein the vertical movement device is adapted to move the build cylinder wall vertically with respect to the carrier together with the irradiation unit.

23. The device as claimed in claim 19, further comprising a further vertical movement device which is adapted to move the build cylinder wall vertically with respect to the carrier.

24. The device as claimed in claim 19, further comprising an inner build cylinder sleeve, wherein a lower edge of the build cylinder sleeve is connected to the carrier and an upper edge of the build cylinder sleeve is movable vertically by the vertical movement device together with the irradiation unit, wherein the inner build cylinder sleeve is adapted to constitute, in the connected state of the wall elements, an inner wall for the raw material powder applied to the carrier, wherein the raw material powder directly adjoins the build cylinder sleeve.

25. The device as claimed in claim 24, wherein the inner build cylinder sleeve comprises at least one of the following elements:
a flexible sleeve of extensible material,
a corrugated bellows, and/or
a plurality of wall segments which are adapted to be stored nested one inside the other in a retracted state and to be deployed in the manner of a telescope into a deployed state.

26. The device as claimed in claim 18, further comprising a connecting device which is adapted to connect the wall elements together during a build process.

27. The device as claimed in claim 18, further comprising a plurality of wall elements which are connected together by means of flexible connections, wherein a first portion of the wall elements is in a vertical state, wherein the wall elements of the first portion in the vertical state form the substantially vertically extending build cylinder wall, and wherein a second portion of the wall elements is in a rolled-up state, wherein the wall elements of the second portion in the rolled-up state do not form the substantially vertically extending build cylinder wall, and wherein the plurality of wall elements is so adapted that wall elements can be unrolled from the rolled-up state into the vertical state, so that the vertical height of the build cylinder wall is increased.

28. The device as claimed in claim 18, wherein the build cylinder wall is formed by a flexible wall of extensible material, wherein a lower edge of the flexible wall is connected to the carrier and an upper edge of the flexible wall is movable vertically by the vertical movement device together with the irradiation unit.

29. The device as claimed in claim 18, further comprising:
a collecting tray for collecting raw material powder which trickles down from the carrier at the sides after completion of a build process and after the build cylinder wall has been at least partially lifted or removed; and
a sealing device which is adapted to guide into the collecting tray the raw material powder which trickles down from the carrier at the sides.

30. A method for producing three-dimensional workpieces using a device for producing three-dimensional workpieces, wherein the method comprises:
applying raw material powder to a carrier;
selectively irradiating the raw material powder applied to the carrier with electromagnetic radiation or particle radiation by an irradiation unit in order to produce on the carrier a workpiece manufactured from the raw material powder by an additive layer building method;
moving the irradiation unit vertically with respect to the carrier by means of a vertical movement device; and
increasing, during a build process, a vertical height of a substantially vertically extending build cylinder wall of the device which constitutes a lateral delimitation for the raw material powder applied to the carrier.

31. The method as claimed in claim 30, wherein the increasing step comprises detachably connecting a plurality of wall elements together so that, in a connected state, they form the substantially vertically extending build cylinder wall.

32. The method as claimed in claim 31, further comprising:
removing at least one of the wall elements, wherein the removed wall element is one of the lowermost wall elements of the build cylinder wall, so that raw material powder is able to trickle down from the carrier at the sides.

33. The method as claimed in claim 31, further comprising:
moving the build cylinder wall vertically upwards, so that a gap forms between a lowermost wall element of the build cylinder wall and the carrier, through which gap raw material powder is able to trickle down from the carrier at the sides.

34. The method as claimed in claim 31, further comprising:
collecting in a collecting tray the raw material powder which trickles down; and
guiding the raw material powder which trickles down into the collecting tray by means of a sealing device.
